(19) United States
(12) Patent Application Publication
(10) Pub. No.: US 2024/0419354 A1
(43) Pub. Date: Dec. 19, 2024

(54) DISK PROCESSING METHOD AND SYSTEM, AND ELECTRONIC DEVICE

(71) Applicant: SUZHOU METABRAIN INTELLIGENT TECHNOLOGY CO., LTD., Suzhou, Jiangsu (CN)

(72) Inventor: Benshuai WEI, Suzhou, Jiangsu (CN)

(21) Appl. No.: 18/724,207

(22) PCT Filed: Dec. 12, 2022
(86) PCT No.: PCT/CN2022/138451

§ 371 Date: Jun. 26, 2024

(30) Foreign Application Priority Data
May 27, 2022 (CN) 202210583933.2

(51) Int. Cl. G06F 3/06

(52) U.S. Cl. CPC G06F 3/0655; G06F 3/0604; G06F 3/0673

(57) ABSTRACT

Provided are a disk processing method and system, an electronic device. The method comprises: when disk alarm information is detected, marking a corresponding alarm disk as a faulty disk; detecting the state of a disk group corresponding to the faulty disk; if the state of the disk group is degraded, marking the faulty disk as an isolation disk, and generating alarm information; if the state of the disk group is healthy, determining whether there is a redundant disk group; if there is no redundant disk group, operating the faulty disk according to a first preset rule, and generating alarm information; if there is a redundant disk group, detecting the state of the redundant disk group, if the state of the redundant disk group is healthy, marking the faulty disk as the isolation disk, generating alarm information, otherwise, operating the faulty disk according to a second preset rule, generating alarm information.

### CROSS-REFERENCE TO RELATED APPLICATIONS

The disclosure claims priority to Chinese Patent Application No. 202210583933.2, entitled “Disk processing method and system, and electronic device”, filed to the China Patent Office on May 27, 2022, the entire contents of which are incorporated herein by reference.

### TECHNICAL FIELD

The disclosure relates to the field of storage technology, and in particular to a disk processing method and system, and an electronic device.

### BACKGROUND

The virtualization technology in cloud computing technology is developing rapidly at present. Facing this development opportunity, Inspur pushes out a super-fusion integrated machine on which the InCloud Rail virtualization system, i.e., the HCl system, is deployed to transform the static and complex IT environment into a more dynamic and manageable virtual data center by the integration, allocation and management of underlying physical resources, which improves the agility, flexibility and efficiency of resource delivery and helps enterprises to create a high-performance, extensible, manageable and flexible server virtualization infrastructure and provide high-quality virtual data center services.

However, the requirements for read-write IO are very strict in the super-fusion integrated machine, and the disk is a key component of read-write IO. Therefore, in order to ensure the continuity of reading and writing of the super-fusion integrated machine, it is necessary to ensure that the super-fusion integrated machine can still work normally when there is a failure or potential failure of a single hard disk. In the current stage, when there is a failure or potential failure of the disk, the super-fusion integrated machine cannot timely sense and send out an alarm. Also, the failure or potential failed disk cannot be isolated, and effective analysis and data protection cannot be performed, so that when there is a real failure, the super-fusion integrated machine cannot normally read and write operations. Even if there is a redundant disk group, data loss may occur, and even the integrated machine system crashes.

### SUMMARY

In order to solve the deficiencies of the prior art, the main object of the disclosure is to provide a disk processing method and system, and an electronic device so as to solve the above-mentioned technical problems of the prior art.

In order to achieve the above object, the disclosure provides, in a first aspect, a disk processing method including:
marking an alarm disk corresponding to disk alarm information as a failed disk according to monitored disk alarm information;
detecting a state of a disk group corresponding to the failed disk, the state including a degraded state and a healthy state;
if the state of the disk group is the degraded state, marking the failed disk as the isolated disk and generating the alert information;
if the state of the disk group is the healthy state, determining whether a redundant disk group exists in the disk group;
if the redundant disk group does not exist in the disk group, operating the failed disk according to a first pre-set rule and generating the alert information; and
if the redundant disk group exists in the disk group, detecting the state of the redundant disk group; if the state of the redundant disk group is the healthy state, marking the failed disk as the isolated disk and generating the alert information; otherwise, operating the failed disk according to a second pre-set rule and generating the alert information.

In some embodiments, the step of operating the failed disk according to a first pre-set rule and generating alert information comprises:
determining a first remaining capacity according to remaining capacities of all the disks of the disk group except the failed disk;
comparing the first remaining capacity with a used capacity corresponding to the failed disk;
if the first remaining capacity is less than the used capacity, generating the alert information;
if the first remaining capacity is greater than or equal to the used capacity, performing data migration on the failed disk;
if the data migration is successful, marking the failed disk as an isolated disk and generating the alert information; and
if the data migration is unsuccessful, generating the alert information.

In some embodiments, the step of operating the failed disk according to a second pre-set rule and generating the alert information comprises:
comparing an original data block in the failed disk with a duplicate data block of a duplicate disk in the redundant disk group;
if the original data block is consistent with the duplicate data block, isolating the failed disk and generating the alert information;
if the original data block is not consistent with the duplicate data block, determining a second remaining capacity according to the remaining capacity of the redundant disk group and comparing the second remaining capacity with the used capacity;
if the second remaining capacity is less than the used capacity, generating the alert information;
performing the data migration on the failed disk if the second remaining capacity is greater than or equal to the used capacity;
if the data migration is successful, marking the failed disk as an isolated disk and generating the alert information; and
if the data migration is unsuccessful, generating the alert information.

In some embodiments, the step of performing data migration on the failed disk comprises:
migrating the original data block to a first target disk in the disk group when the redundant disk group does not exist in the disk group;
migrating the original data block to a second target disk in the redundant disk group when the redundant disk group exists in the disk group; and
recording a latest physical address of the original data block after migration and storing the same in a memory.

In some embodiments, the step of performing data migration on the failed disk comprises:
if a write operation occurs to the original data block during the data migration, caching a modified content corresponding to the write operation in the memory; and
after the data migration is successful, writing the modified content into the first target disk or the second target disk according to the latest physical address.

In some embodiments, the step of determining process of successful data migration comprises:
comparing a data block parameter of the failed disk with that of the first target disk or the second target disk;
if the data block parameter of the failed disk is consistent with that of the first target disk or the second target disk, indicating that the data migration is successful; and
if the data block parameter of the failed disk is not consistent with the first target disk or the second target disk, indicating that the data migration is unsuccessful;
wherein the data block parameter comprises a quantity of data blocks, data block header information and a data block health state.

In some embodiments, the step of marking an alarm disk corresponding to disk alarm information as a failed disk according to monitored disk alarm information further comprises:
monitoring system alarm information about each physical node host and retrieving whether the disk alarm information exists in the system alarm information;
if the disk alarm information exists, recording a drive letter and a host IP address of the alarm disk; and
locating and calling a host according to the host IP address, and recording the alarm disk information, wherein the alarm disk information comprises a drive letter of the alarm disk, a serial number of the alarm disk and a physical slot of the alarm disk.

In some embodiments, the method further comprises:
locating a physical location of the isolated disk according to the alarm disk information;
removing the isolated disk and adding a new disk based on the physical location;
reading a serial number of the new disk, and generating a fault disk prompt if the serial number of the new disk is consistent with the recorded serial number of the alarm disk; and
if the serial number of the new disk does not match with the recorded serial number of the alarm disk, generating an add success prompt.

A second aspect of the present application disclose a disk processing system including:
a monitor module configured for marking an alarm disk corresponding to disk alarm information as a failed disk according to monitored disk alarm information;
a verification module configured for detecting a state of a disk group corresponding to the failed disk, the state including a degraded state and a healthy state;
an isolation alert module configured for, when the state of the disk group is the degraded state, marking the failed disk as the isolated disk and generating the alert information;
wherein the verification module is further configured for, when the state of the disk group is the healthy state, determining whether a redundant disk group exists in the disk group;
the isolation alert module is further configured for, when the redundant disk group does not exist in the disk group, operating the failed disk according to a first pre-set rule and generating the alert information;
the verification module is further configured for, when the redundant disk group exists in the disk group, detecting the state of the redundant disk group; and
the isolation alert module is further configured for, when the state of the redundant disk group is the healthy state, marking the failed disk as the isolated disk and generating the alert information; otherwise, operating the failed disk according to a second pre-set rule and generating the alert information.

A third aspect of the present application discloses an electronic device including:
one or more processors; and
a storage associated with the one or more processors for storing program instructions that, when read and executed by the one or more processors, perform operations including:
marking an alarm disk corresponding to disk alarm information as a failed disk according to monitored disk alarm information;
detecting a state of a disk group corresponding to the failed disk, the state including a degraded state and a healthy state;
if the state of the disk group is the degraded state, marking the failed disk as the isolated disk and generating the alert information;
if the state of the disk group is the healthy state, determining whether a redundant disk group exists in the disk group;
if the redundant disk group does not exist in the disk group, operating the failed disk according to a first pre-set rule and generating the alert information; and
if the redundant disk group exists in the disk group, detecting the state of the redundant disk group; if the state of the redundant disk group is the healthy state, marking the failed disk as the isolated disk and generating the alert information; otherwise, operating the failed disk according to a second pre-set rule and generating the alert information.

The beneficial effects achieved by the disclosure are as follows.

The disclosure provides a disk processing method, including marking an alarm disk corresponding to disk alarm information as a failed disk according to monitored disk alarm information; detecting a state of a disk group corresponding to the failed disk, the state including a degraded state and a healthy state; if the state of the disk group is the degraded state, marking the failed disk as the isolated disk and generating the alert information; if the state of the disk group is the healthy state, determining whether a redundant disk group exists in the disk group; if the redundant disk group does not exist in the disk group, operating the failed disk according to a first pre-set rule and generating the alert information; and if the redundant disk group exists in the disk group, detecting the state of the redundant disk group; if the state of the redundant disk group is the healthy state, marking the failed disk as the isolated disk and generating the alert information; otherwise, operating the failed disk according to a second pre-set rule and generating the alert information. By checking the state of the disk group corresponding to the alarm disk and the redundant disk group, the alarm disk meeting the conditions is selectively isolated so as to avoid the alarm disk failing to read and write normally in the subsequent operation, ensuring the normal operation of the super-fusion integrated machine, and improving the robustness of the super-fusion integrated machine. In addition, data block migration and consistency check are performed on the disk which meets the migration conditions to ensure the security and continuity of data and eliminate the risk of data loss.

### BRIEF DESCRIPTION OF THE DRAWINGS

In order to more clearly illustrate the technical solutions in the embodiments of the disclosure, the drawings to be used in the description of the embodiments will be briefly introduced below. Obviously, the drawings in the description below are only some embodiments of the disclosure. It will be apparent to those skilled in the art to obtain other drawings according to these drawings without involving any inventive effort.

FIG. 1 is a schematic diagram of failed disk processing provided by some embodiments of the disclosure;

FIG. 2 is a flow diagram of a disk processing method provided by some embodiments of the disclosure.

FIG. 3 is a structure diagram of a disk processing system provided by some embodiments of the disclosure; and

FIG. 4 is a structure diagram of an electronic device provided by some embodiments of the disclosure.

### DETAILED DESCRIPTION OF THE EMBODIMENTS

In order to make the objectives, technical solutions, and advantages of the disclosure clearer, the technical solutions in the embodiments of the disclosure will be described clearly and completely in conjunction with the accompanying drawings in the embodiments of the disclosure. Obviously, the described embodiments are only part of the embodiments of the disclosure, rather than all of the embodiments. Based on the embodiments in the disclosure, all other embodiments obtained by a person skilled in the art without involving any inventive effort are within the scope of protection of the disclosure.

It should to be understood that throughout the description of the disclosure and the claims, unless the context clearly requires otherwise, the words “comprise”, “comprising” and the like are to be construed in an inclusive sense as opposed to an exclusive or exhaustive sense. That is, there is a meaning of “including, but not limited to”.

It should be understood that the terms “first”, “second” and the like are used solely for descriptive purposes and are not to be construed as indicating or implying relative importance. In the description of the disclosure, the meaning of “a plurality” is two or more, unless otherwise noted.

It should be noted that the terms “S1”, “S2”, and the like are used for the purpose of describing the steps only, and are not intended to be a special reference to the order or sequence of steps, nor to limit the disclosure, which is merely for the convenience of describing the methods of the disclosure and is not to be construed as indicating a sequential or chronological order of steps. In addition, the technical solutions between the various embodiments may be combined with each other, but must be realized by a person of ordinary skill in the art. When the combination of technical solutions is contradictory or cannot be realized, it should be considered that the combination of technical solutions does not exist and is not within the scope of protection claimed in the disclosure.

As described in the background art, when dealing with a fault or a potential fault, it cannot isolate a fault disk or a potential fault disk the prior art, resulting in an influence on the read-write continuity of the super-fusion integrated machine. Even if there is a redundant disk group, when a fault occurs, the super-fusion integrated machine cannot read and write normally, and even an integrated machine system crash may occur.

In order to solve the above-mentioned technical problem, the disclosure provides a disk processing method applied to a super-fusion integrated machine, which selectively isolates a disk which may generate a fault and migrates and protects data, effectively preventing the problem of data loss and improving the stability of the read-write performance of the super-fusion integrated machine.

It should be noted that the disclosure can be applied to any other device and scenario requiring the isolation of the failed or potentially failed disk, in addition to the super-fusion integrated machine, under the condition that a drive letter, a serial number and a physical slot can be acquired.

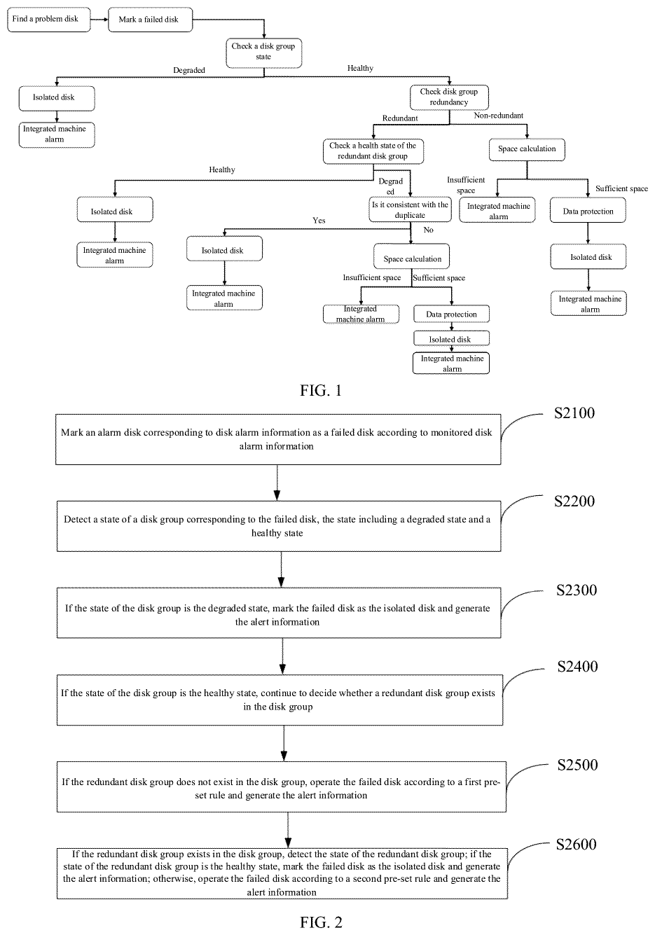

In order to realize the disk processing method disclosed in the disclosure, some embodiments of the disclosure provide a failed disk alert system, including an alarm unit, a disk isolation unit, a space calculation unit and a data protection unit. As shown in FIG. 1, the process of applying the failed disk alert system disclosed in some embodiments of the disclosure to perform disk isolation and data protection includes:

S100, when it is detected that the disk alarm information exists, a disk corresponding to the disk alarm information is marked and the disk is located.

According to some embodiments, the alarm unit scans and collects system alarm information about each logistics node of the super-fusion integrated machine in real time; and retrieves whether disk alarm information exists in the system alarm information. If the disk alarm information exists, the alarm unit records the drive letter of the disk corresponding to the disk alarm information and the host IP address where the disk is located.

The IP address of the host can be located to a specific host. At this time, by remotely invoking the smartctl service of the host, relevant information about all the disks in the host is output into a disk information table. smartctl is an executable command after the installation of the Smartmontools tool, from which we can see if the disk supports smart tests, perform smart tests, etc. Smartmontools is a hard disk detection tool, which is realized by SMART (Self Monitoring Analysis and Reporting Technology) technology to control and manage the hard disk, and the automatic detection analysis and reporting technology. SMART technology may monitor the magnetic head unit of the hard disk, the disk motor drive system, the internal circuit of the hard disk and the media material on the surface of the disk, etc. When SMART monitors and analyzes the possible problems of the hard disk, it will timely alert the user to avoid the loss of computer data. In the art, it is feasible to use Smartctl to view basic parameters of a hard disk, all SMART information and non-SMART information about the hard disk, and view all devices on a system and view the healthy state of the hard disk. Therefore, the disclosure can acquire relevant information about a required disk by calling a smartctl service of a host.

It searches for relevant information about a physical disk corresponding to the alarm disk information by using a key word in the disk alarm information in a disk information table so as to acquire a serial number (SN number) of the physical disk. It acquires and records physical slot information corresponding to the physical disk via an IPMI (Intelligent Platform Management Interface) protocol. According to the above-mentioned steps, a drive letter, a serial number and a physical slot corresponding to the disk alarm information and an IP address of a host where the alarm disk have been acquired and recorded. The alarm disk is marked as a failed disk based on the foregoing information.

S200, the state of the disk group corresponding to the failed disk is checked, and the isolated disk is marked when the disk group state is a degraded state and the alert information is generated.

According to some embodiments, firstly, the disk isolation unit locates a disk group where the failed disk is located via the drive letter of the failed disk and the IP address of the host where the failed disk is located. Then, the state of the disk group is checked. If the state of the disk group is a degraded state, wherein the degraded meaning is that the hard disk or the array has been near to be damaged. Hence, in the case where there is a problem in the disk group, the disclosure marks the failed disk as an isolated disk so as to force deletion of the failed disk from the disk group. Finally, an alarm unit sends out alert information, wherein the alert information includes a drive letter of the alarm disk, a serial number of the alarm disk, and a physical slot of the alarm disk of the failed disk, so that a user locates a physical location corresponding to the failed disk.

S300, when the state of the disk group is a healthy state, the disk isolation unit queries the redundancy situation of the disk group of the super-fusion integrated machine. When the redundant disk group does not exist, a first pre-set rule is executed to operate the failed disk and generate alert information. When the redundant disk group exists, a second pre-set rule is executed to operate on the failed disk and generate alert information.

When the redundant disk group does not exist, the first pre-set rule is executed to operate the failed disk and generate the alert information. The process includes:

S310, the space calculation unit calculates a first remaining capacity and a used capacity of the failed disk, wherein the first remaining capacity is the total remaining capacity of all the disks of the disk group corresponding to the failed disk except the failed disk.

S311, the disk isolation unit compares the first remaining capacity with the used capacity. If the used capacity is greater than the first remaining capacity, that is to say, the remaining space in the disk group is insufficient to store the data in the failed disk. At this time, if the failed disk is isolated, the data will be lost, and the super-fusion integrated machine cannot operate on the original data in the failed disk. In this case, the disclosure does not mark the failed disk as an isolated disk, but directly generates alert information via an alarm unit so as to notify a user to perform operations such as subsequent repair on the failed disk. If the used capacity is less than or equal to the first remaining capacity, the data protection unit sends a data migration instruction to migrate the original data block in the failed disk to the first target disk in the disk group, i.e., the data in the failed disk is migrated by taking the data block as a basic unit. At the same time of migration, the new physical address of the data block, i.e., the physical address of the first target disk, is recorded into the memory. Note that at this time, if a write operation occurs to a data block, the changed contents of the write operation will be cached in the memory. After the original data block in the failed disk is migrated to the first target disk, the changed contents of the above-mentioned write operation will be written to the first target disk according to the physical address of the first target disk previously recorded in the memory.

S312, after the original data block in the failed disk is migrated to the first target disk, the data protection unit verifies whether the original data block maintains consistency before and after the migration. The data protection unit compares data blocks in the failed disk with data block parameters in the migrated first target disk, such as a number of data blocks, data block header information and data block health state. If the data block parameters in the failed disk and the first target disk are completely consistent, it indicates that the migration is successful. At this moment, the disk isolation unit marks the failed disk as an isolated disk, and the alarm unit sends out alert information. If the data block parameters in the failed disk and the first target disk are not consistent, it indicates that the migration is not successful. At this time, if the failed disk is isolated, the data will be lost. Therefore, the disk isolation unit will not mark the failed disk as an isolated disk, and the alert information is only sent out by the alarm unit.

When a redundant disk group exists, a failed disk is operated to generate alert information. The process includes:

S320, the disk isolation unit detects the state of the redundant disk group. If the redundant disk group is in a healthy state, the disk isolation unit marks the failed disk as an isolated disk, and the alarm unit sends out alert information. The reason is that the redundant disk group is equivalent to the backup of the disk group. In order to avoid that a problem may occur in a failed disk later, resulting in a decrease in the read-write performance of the super-fusion integrated machine, the disclosure directly isolates the failed disk which may have a failure, and uses a healthy redundant disk group to read and write data. At this time, it is unnecessary to perform other verification operations on the disk group corresponding to the failed disk, so as to improve the speed of isolating the failed disk. If the redundant disk group is in a degraded state, the second pre-set rule is executed to operate on the failed disk and generate the alert information.

Herein, the above-mentioned redundant disk group is in the degraded state, and the second pre-set rule is executed to operate on the failed disk and generate the alert information. The process includes:

S321, the space calculation unit compares an original data block parameter in the failed disk with a duplicate data block parameter in the corresponding duplicate disk in the redundant disk group, such as a quantity of data blocks, data block information, data block health state, etc.; if the original data block parameter is consistent with the duplicate data block parameter, that is to say, it is proved that the duplicate data block in the duplicate disk has no problem; the disk isolation unit marks the failed disk as an isolated disk, and an alarm unit sends out alert information; if the original data block parameter is not consistent with the duplicate data block parameter, that is to say, it is proved that there is a problem in the duplicate data block in the duplicate disk; at this moment, in order to realize the isolation of the failed disk, the disk isolation unit migrates the original data block in the failed disk without a problem into the redundant disk group.

S322, the space calculation unit calculates a second remaining capacity, which is the remaining space capacity of the redundant disk group, and the used capacity of the failed disk.

S323, the disk isolation unit compares the second remaining capacity with the used capacity. If the used capacity is greater than the second remaining capacity, that is to say, the remaining space in the redundant disk group is insufficient to store the data in the failed disk. At this time, if the failed disk is isolated, the data will be lost, and the super-fusion integrated machine cannot operate on the original data in the failed disk. In this case, the disclosure does not mark the failed disk as an isolated disk, but directly generates alert information via an alarm unit so as to notify a user to perform operations such as subsequent repair on the failed disk. If the used capacity is less than or equal to the second remaining capacity, the data protection unit sends a data migration instruction to migrate the original data block in the failed disk to the second target disk in the redundant disk group. At the same time of the migration, the new physical address of the data block, i.e., the physical address of the second target disk, is recorded into the memory. Note that at this time, if a write operation occurs to the data block, the changed contents of the write operation will be cached in the memory. After the original data block in the failed disk is migrated to the second target disk, the changed contents of the above-mentioned write operation will be written to the second target disk according to the physical address of the second target disk previously recorded in the memory.

S324, after the original data block in the failed disk is migrated to the second target disk, the data protection unit verifies whether the original data block maintains consistency before and after the migration. The data protection unit compares data blocks in the failed disk with data block parameters in the migrated second target disk, such as a number of data blocks, data block header information and data block health state. If the data block parameters in the failed disk and the first target disk are completely consistent, it indicates that the migration is successful. At this moment, the disk isolation unit marks the failed disk as an isolated disk, and the alarm unit sends out alert information. If the data block parameters in the failed disk and the second target disk are not consistent, it indicates that the migration is not successful. At this time, if the failed disk is isolated, the data will be lost. Therefore, the disk isolation unit will not mark the failed disk as an isolated disk, and the alert information is only sent out by the alarm unit.

S400, for a failed disk marked as an isolated disk, the integrated machine forcibly deletes the isolated disk and relevant information in the disk group, and sets the disk as an off-line state after the deletion.

In addition, the user can locate the position of the isolated physical disk according to the slot information in the alert information sent by the alarm unit, and can manually perform physical disk removal or replacement with a new physical disk. When a new physical disk is inserted, the super-fusion integrated machine reads the serial number of the new physical disk, and compares the serial number corresponding to the isolated disk previously recorded in the super-fusion integrated machine. If the serial numbers are inconsistent, the super-fusion integrated machine decides that the newly inserted physical disk is a new disk, and the integrated machine sends a prompt of whether to add a physical disk to the disk group. It generates a prompt of successful addition after the user confirms the addition. If the serial numbers are consistent, the inserted physical disk is the original isolated disk, and the integrated machine sends a failed disk prompt, for example, a prompt that the newly inserted physical disk is a failed disk and whether to add it to the disk group.

Based on the disk processing method disclosed in the embodiments of the disclosure, the super-fusion integrated machine can isolate a failed disk having a failure or a potential failure without destroying data read-write continuity, thereby improving the stability of the integrated machine.

Corresponding to the above-mentioned embodiments, some embodiments of the disclosure provide a disk processing method, as shown in FIG. 2. The method includes the following steps.

S2100, an alarm disk corresponding to disk alarm information is marked as a failed disk according to monitored disk alarm information.

In some embodiments, the marking an alarm disk corresponding to disk alarm information as a failed disk according to monitored disk alarm information further includes:
S2110, monitoring system alarm information about each physical node host and retrieving whether the disk alarm information exists in the system alarm information;
S2120, if the disk alarm information exists, recording a drive letter and a host IP address of the alarm disk;
S2130, locating and calling a host according to the host IP address, and recording the alarm disk information, wherein the alarm disk information includes a drive letter of the alarm disk, a serial number of the alarm disk and a physical slot of the alarm disk;
S2200, detecting a state of a disk group corresponding to the failed disk, the state including a degraded state and a healthy state;
S2300, if the state of the disk group is the degraded state, marking the failed disk as the isolated disk and generating the alert information;
S2400, if the state of the disk group is the healthy state, determining whether a redundant disk group exists in the disk group; and
S2500, if the redundant disk group does not exist in the disk group, operating the failed disk according to a first pre-set rule and generating the alert information.

In some embodiments, the operating the failed disk according to a first pre-set rule and generating alert information includes:
S2510, determining a first remaining capacity according to remaining capacities of all the disks of the disk group except the failed disk;
S2520, comparing the first remaining capacity with a used capacity corresponding to the failed disk;
S2530, if the first remaining capacity is less than the used capacity, generating the alert information;
S2540, if the first remaining capacity is greater than or equal to the used capacity, performing data migration on the failed disk;
S2550, if the data migration is successful, marking the failed disk as an isolated disk and generating the alert information;
S2560, if the data migration is unsuccessful, generating the alert information; and
S2600, if the redundant disk group exists in the disk group, detecting the state of the redundant disk group; if the state of the redundant disk group is the healthy state, marking the failed disk as the isolated disk and generating the alert information; otherwise, operating the failed disk according to a second pre-set rule and generating the alert information.

In some embodiments, the operating the failed disk according to a second pre-set rule and generating alert information includes:
S2610, comparing an original data block in the failed disk with a duplicate data block of a duplicate disk in the redundant disk group;
S2620, if the original data block is consistent with the duplicate data block, isolating the failed disk and generating the alert information;
S2630, if the original data block is not consistent with the duplicate data block, determining a second remaining capacity according to the remaining capacity of the redundant disk group and comparing the second remaining capacity with the used capacity;
S2640, if the second remaining capacity is less than the used capacity, generating the alert information; and
S2650, if the second remaining capacity is greater than or equal to the used capacity, performing data migration on the failed disk.

In some embodiments, the performing data migration on the failed disk includes:
S2651, migrating the original data block to a first target disk in the disk group when the redundant disk group does not exist in the disk group;
S2652, migrating the original data block to a second target disk in the redundant disk group when the redundant disk group exists in the disk group; and
S2653, recording a latest physical address of the original data block after migration and storing the same in a memory.

In some embodiments, the performing data migration on the failed disk further includes:
S2654, if a write operation occurs to the original data block during the data migration, caching a modified content corresponding to the write operation in the memory; and
S2655, after the data migration is successful, writing the modified content into the first target disk or the second target disk according to the latest physical address;
S2660, if the data migration is successful, marking the failed disk as an isolated disk and generating the alert information; and
S2670, if the data migration is unsuccessful, generating the alert information; and
In some embodiments, the process of determining the successful data migration includes:
S2671, comparing a data block parameter of the failed disk with that of the first target disk or the second target disk;
S2672, if the data block parameter of the failed disk is consistent with that of the first target disk or the second target disk, indicating that the data migration is successful; and
S2673, if the data block parameter of the failed disk is not consistent with the first target disk or the second target disk, indicating that the data migration is unsuccessful;
wherein the data block parameter includes a quantity of data blocks, data block header information and a data block health state.

In some embodiments, the method further includes:
S2674, locating a physical location of the isolated disk according to the alarm disk information;
S2675, removing the isolated disk and adding a new disk based on the physical location;
S2676, reading a serial number of the new disk, and generating a fault disk prompt if the serial number of the new disk is consistent with the recorded serial number of the alarm disk; and
S2677, if the serial number of the new disk does not match with the recorded serial number of the alarm disk, generating an add success prompt.

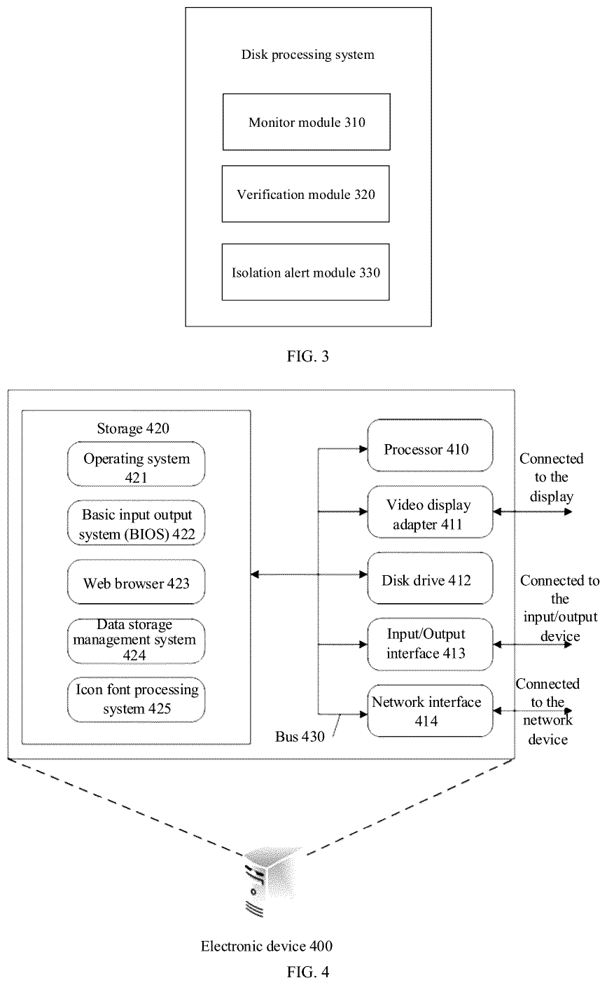

Corresponding to some of the above-mentioned embodiments, as shown in FIG. 3, some embodiments of the disclosure further provide a disk processing system, the system including:
a monitor module 310 configured for marking an alarm disk corresponding to disk alarm information as a failed disk according to monitored disk alarm information;
a verification module 320 configured for detecting a state of a disk group corresponding to the failed disk, the state including a degraded state and a healthy state;
an isolation alert module 330 configured for, when the state of the disk group is the degraded state, marking the failed disk as the isolated disk and generating the alert information;
wherein the verification module 320 is further configured for, when the state of the disk group is the healthy state, determining whether a redundant disk group exists in the disk group;
the isolation alert module 330 is further configured for, when the redundant disk group does not exist in the disk group, operating the failed disk according to a first pre-set rule and generating the alert information;
the verification module 320 is also configured for, when the redundant disk group exists in the disk group, detecting the state of the redundant disk group; and
the isolation alert module 330 is further configured for, when the state of the redundant disk group is the healthy state, marking the failed disk as the isolated disk and generating the alert information; otherwise, operating the failed disk according to a second pre-set rule and generating the alert information.

In some embodiments, the isolation alert module 330 is further configured for determining a first remaining capacity according to remaining capacities of all the disks of the disk group except the failed disk; comparing the first remaining capacity with a used capacity corresponding to the failed disk; if the first remaining capacity is less than the used capacity, generating the alert information; if the first remaining capacity is greater than or equal to the used capacity, performing data migration on the failed disk; if the data migration is successful, marking by the isolation alert module 330 the failed disk as an isolated disk and generating the alert information; and if the data migration is unsuccessful, generating the alert information by the isolation alert module 330.

In some embodiments, the isolation alert module 330 is also configured for comparing an original data block in the failed disk with a duplicate data block of a duplicate disk in the redundant disk group; if the original data block is consistent with the duplicate data block, isolating the failed disk and generating the alert information by the isolation alert module 330; if the original data block is not consistent with the duplicate data block, determining a second remaining capacity according to the remaining capacity of the redundant disk group and comparing the second remaining capacity with the used capacity; if the second remaining capacity is less than the used capacity, generating the alert information by the isolation alert module 330; if the second remaining capacity is greater than or equal to the used capacity, performing data migration on the failed disk; if the data migration is successful, marking by the isolation alert module 330 the failed disk as an isolated disk and generating the alert information; and if the data migration is unsuccessful, generating the alert information by the isolation alert module 330.

In some embodiments, when the redundant disk group does not exist in the disk group, the isolation alert module 330 is further configured for migrating the original data block to a first target disk in the disk group; migrating by the isolation alert module 330 the original data block to a second target disk in the redundant disk group when the redundant disk group exists in the disk group; and recording by isolation alert module 330 a latest physical address of the original data block after migration and storing the same in a memory.

In some embodiments, the isolation alert module 330 is further configured for caching a modified content corresponding to a write operation in a memory when the write operation occurs on the original data block in the case of data migration. The isolation alert module 330 is further configured for writing the modified content into the first target disk or the second target disk according to the latest physical address after the data migration is successful.

In some embodiments, the isolation alert module 330 is further configured for comparing a data block parameter of the failed disk with that of the first target disk or the second target disk; if the data block parameter of the failed disk is consistent with that of the first target disk or the second target disk, indicating that the data migration is successful; and if the data block parameter of the failed disk is not consistent with the first target disk or the second target disk, indicating that the data migration is unsuccessful; wherein the data block parameter includes a quantity of data blocks, data block header information and a data block health state.

In some embodiments, the monitor module 310 is further configured for monitoring system alarm information about each physical node host and retrieving whether the disk alarm information exists in the system alarm information; if the disk alarm information exists, recording by the monitor module 310 a drive letter and a host IP address of the alarm disk; and locating and calling a host according to the host IP address, and recording the alarm disk information, wherein the alarm disk information includes a drive letter of the alarm disk, a serial number of the alarm disk and a physical slot of the alarm disk.

In some embodiments, the isolation alert module 330 is also configured for locating a physical location of the isolated disk according to the alarm disk information; removing the isolated disk and adding a new disk based on the physical location by the user; reading a new disk serial number by the super-fusion integrated machine, and generating a fault disk prompt by the super-fusion integrated machine if the new disk serial number is consistent with the recorded alarm disk serial number; and if the new disk serial number is not consistent with the recorded serial number of the alarm disk, generating an add success prompt by the super-fusion integrated machine.

Corresponding to all the embodiments described above, some embodiments of the disclosure provide an electronic device including: one or more processors; and a storage associated with the one or more processors for storing program instructions that, when read and executed by the one or more processors, perform the operations of:
marking an alarm disk corresponding to disk alarm information as a failed disk according to monitored disk alarm information;
detecting a state of a disk group corresponding to the failed disk, the state including a degraded state and a healthy state;
if the state of the disk group is the degraded state, marking the failed disk as the isolated disk and generating the alert information;
if the state of the disk group is the healthy state, determining whether a redundant disk group exists in the disk group;
if the redundant disk group does not exist in the disk group, operating the failed disk according to a first pre-set rule and generating the alert information; and
if the redundant disk group exists in the disk group, detecting the state of the redundant disk group; if the state of the redundant disk group is the healthy state, marking the failed disk as the isolated disk and generating the alert information; otherwise, operating the failed disk according to a second pre-set rule and generating the alert information.

FIG. 4 exemplarily illustrates the architecture of an electronic device, which may include a processor 410, a video display adapter 411, a disk drive 412, an input/output interface 413, a network interface 414, and a storage 420. The processor 410, the video display adapter 411, the disk drive 412, the input/output interface 413, the network interface 414, and the storage 420 may be communicatively coupled via a bus 430.

The processor 410 may be implemented by a general-purpose CPU (Central Processing Unit), a microprocessor, an application specific integrated circuit (ASIC), or one or more integrated circuits, etc. for executing relevant programs to implement the technical solutions provided in the disclosure.

The storage 420 may be implemented in the form of an ROM (Read Only Memory), an RAM (Random Access Memory), a static storage device, a dynamic storage device, etc. The storage 420 may store an operating system 421 for controlling the execution of the electronic device 400, a basic input output system (BIOS) 422 for controlling the low-level operation of the electronic device 400. In addition, a web browser 423, a data storage management system 424, an icon font processing system 425, and the like may also be stored. The icon font processing system 425 may be an application program that implements the operations of the foregoing steps in some embodiments of the disclosure. In general, when the techniques provided herein are implemented in software or firmware, the associated program code is stored in storage 420 and called for execution by the processor 410.

The input/output interface 413 is used to connect input/output modules to realize information input and output. The input/output modules may be provided as components in the device (not shown in the figure) or may be external to the device to provide corresponding functions. The input device may include a keyboard, a mouse, a touch screen, a microphone, various types of sensors, etc. The output device may include a display, a speaker, a vibrator, an indicator lamp, etc.

The network interface 414 is used to connect a communication module (not shown) to enable the device to interact with other devices. The communication module can realize communication through a wired mode (such as USB, network cable, etc.), and can also realize communication through a wireless mode (such as mobile network, WIFI, bluetooth, etc.).

The bus 430 includes a path to transfer information among various components of the device (e.g., a processor 410, a video display adapter 411, a disk drive 412, an input/output interface 413, a network interface 414, and a storage 420).

In addition, the electronic device 400 may also obtain information on specific conditions of retrieval from a virtual resource object retrieval condition information database for use in condition determination, etc.

It should be noted that although the above-described device shows only the processor 410, the video display adapter 411, the disk drive 412, the input/output interface 413, the network interface 414, the storage 420, the bus 430, etc., the device may also include other components necessary for proper execution in a specific implementation. Moreover, those skilled in the art will appreciate that the device described above may include only the components necessary to implement the inventive arrangements and not necessarily all of the components illustrated in the drawings.

As known from the above description of the embodiments, it will be clear to a person skilled in the art that the disclosure can be implemented by means of software plus a necessary general hardware platform. Based on this understanding, the above-described technical solutions of the disclosure may be essentially or in a part of making a contribution to the prior, embodied in the form of a software product, which may be stored in a computer readable storage medium, such as ROM/RAM, diskettes, optical disks, etc., including instructions for causing a computer device (which may be a phone, a personal computer, a server, or a network device, etc.) to perform the methods described in the various embodiments or in some parts of the embodiments.

The various examples in this manual are described in a progressive manner, with similar parts between the embodiments being cross-referenced for ease of understanding. Each embodiment focuses on highlighting the differences from the other embodiments. Particularly, for system or system implementation embodiments, since they are essentially similar to method implementation embodiments, they are described more succinctly, and the relevant parts can be referenced from the method implementation embodiments. The systems and system implementation embodiments described above are illustrative only. The components described as separate entities may or may not be physically separated, and the components displayed as units may or may not be physical units, that is, they can be located in one place or distributed across multiple network units. Depending on actual needs, some or all modules can be selected to achieve the purpose of this implementation embodiment. A person of ordinary skill in the art can understand and implement without creative effort.

The above is only a preferred embodiment of this application and is not intended to limit the scope of this application. Any modifications, equivalent substitutions, improvements, etc., made within the spirit and principles of this application, should be included within the scope of protection of this application.

1. A disk processing method, wherein the method comprises:
marking an alarm disk corresponding to disk alarm information as a failed disk according to monitored disk alarm information;
detecting a state of a disk group corresponding to the failed disk, the state including a degraded state and a healthy state;
in response to that the state of the disk group is the degraded state, marking the failed disk as the isolated disk and generating the alert information;
in response to that the state of the disk group is the healthy state, determining whether a redundant disk group exists in the disk group;
in response to that the redundant disk group does not exist in the disk group, operating the failed disk according to a first pre-set rule and generating the alert information; and
in response to that the redundant disk group exists in the disk group, detecting the state of the redundant disk group; if the state of the redundant disk group is the healthy state, marking the failed disk as the isolated disk and generating the alert information; otherwise, operating the failed disk according to a second pre-set rule and generating the alert information.

2. The method according to claim 1, wherein the degraded state is used to characterize that a hard disk or an array in the disk group has imminent damage.

3. The method according to claim 1, wherein the operating the failed disk according to a first pre-set rule and generating alert information comprises:
determining a first remaining capacity according to remaining capacities of all the disks of the disk group except the failed disk;
comparing the first remaining capacity with a used capacity corresponding to the failed disk;
in response to that the first remaining capacity is less than the used capacity, generating the alert information;
in response to that the first remaining capacity is greater than or equal to the used capacity, performing data migration on the failed disk;
in response to that the data migration is successful, marking the failed disk as an isolated disk and generating the alert information; and
in response to that the data migration is unsuccessful, generating the alert information.

4. The method according to claim 3, wherein the operating the failed disk according to a second pre-set rule and generating the alert information comprises:
comparing an original data block in the failed disk with a duplicate data block of a duplicate disk in the redundant disk group;
in response to that the original data block is consistent with the duplicate data block, isolating the failed disk and generating the alert information;
in response to that the original data block is not consistent with the duplicate data block, determining a second remaining capacity according to the remaining capacity of the redundant disk group and comparing the second remaining capacity with the used capacity;
in response to that the second remaining capacity is less than the used capacity, generating the alert information;
performing the data migration on the failed disk if the second remaining capacity is greater than or equal to the used capacity;
in response to that the data migration is successful, marking the failed disk as an isolated disk and generating the alert information; and
in response to that the data migration is unsuccessful, generating the alert information.

5. The method according to claim 4, wherein the performing data migration on the failed disk comprises:
migrating the original data block to a first target disk in the disk group when the redundant disk group does not exist in the disk group;
migrating the original data block to a second target disk in the redundant disk group when the redundant disk group exists in the disk group; and
recording a latest physical address of the original data block after migration and storing the same in a memory.

6. The method according to claim 5, wherein the performing data migration on the failed disk comprises:
in response to that a write operation occurs to the original data block during the data migration, caching a modified content corresponding to the write operation in the memory; and
after the data migration is successful, writing the modified content into the first target disk or the second target disk according to the latest physical address.

7. The method according to claim 5, wherein the determining process of successful data migration comprises:
comparing a data block parameter of the failed disk with that of the first target disk or the second target disk;
in response to that the data block parameter of the failed disk is consistent with that of the first target disk or the second target disk, indicating that the data migration is successful; and
in response to that the data block parameter of the failed disk is not consistent with the first target disk or the second target disk, indicating that the data migration is unsuccessful;
wherein the data block parameter comprises a quantity of data blocks, data block header information and a data block health state.

8. The method according to claim 7, wherein the marking an alarm disk corresponding to disk alarm information as a failed disk according to monitored disk alarm information further comprises:
monitoring system alarm information about each physical node host and retrieving whether the disk alarm information exists in the system alarm information;
in response to that the disk alarm information exists, recording a drive letter and a host IP address of the alarm disk; and
locating and calling a host according to the host IP address, and recording the alarm disk information, wherein the alarm disk information comprises a drive letter of the alarm disk, a serial number of the alarm disk and a physical slot of the alarm disk.

9. The method according to claim 8, wherein the monitoring system alarm information about each physical node host and retrieving whether the disk alarm information exists in the system alarm information comprises:
scanning and collecting the system alarm information in real time; and
retrieving the system alarm information to determine whether the disk alarm information exists in the system alarm information.

10. The method according to claim 8, wherein the recording the alarm disk information comprises:
looking up a serial number of a disk corresponding to the alarm disk information from a disk information table by using a key word in the disk alarm information.

11. The method according to claim 8, wherein the recording the alarm disk information comprises:
acquiring and recording a physical slot of a disk corresponding to the disk alarm information via an intelligent platform management interface (IPMI) protocol.

12. The method according to claim 8, wherein the marking an alarm disk corresponding to disk alarm information as a failed disk according to monitored disk alarm information comprises:
marking an alarm disk corresponding to the disk alarm information as a failed disk according to the drive letter, the serial number, the physical slot of the disk corresponding to the disk alarm information and the host IP address where the disk is located.

13. The method according to claim 8, wherein the method further comprises:
locating a physical location of the isolated disk according to the alarm disk information;
removing the isolated disk and adding a new disk based on the physical location;
reading a serial number of the new disk, and generating a fault disk prompt if the serial number of the new disk is consistent with the recorded serial number of the alarm disk; and
in response to that the serial number of the new disk does not match with the recorded serial number of the alarm disk, generating an add success prompt.

14. The method according to claim 1, wherein the redundant disk group is used to serve as a backup for the disk group.

15. The method according to claim 1, after the marking the failed disk as an isolated disk and generating the alert information, the method further comprises:
deleting the isolated disk and its related information and setting the isolated disk to an offline state.

16. The method according to claim 1, wherein the failed disk is a failed or potentially failed disk.

17. The method according to claim 1, wherein the alert information includes a drive letter of the alarm disk, a serial number of the alarm disk, and a physical slot of the alarm disk.

18. The method according to claim 1, wherein the disk processing method is applied to a failed disk alert system including an alarm unit, a disk isolation unit, a space calculation unit, and a data protection unit.

19. (canceled)

20. An electronic device, wherein the electronic device comprises:
one or more processors; and
a storage associated with the one or more processors for storing program instructions that, when read and executed by the one or more processors, perform the method according to claim 1.

21. The electronic device according to claim 20, wherein the step of operating the failed disk according to a first pre-set rule and generating alert information comprises:
determining a first remaining capacity according to remaining capacities of all the disks of the disk group except the failed disk;
comparing the first remaining capacity with a used capacity corresponding to the failed disk;
in response to that the first remaining capacity is less than the used capacity, generating the alert information;
in response to that the first remaining capacity is greater than or equal to the used capacity, performing data migration on the failed disk;
in response to that the data migration is successful, marking the failed disk as an isolated disk and generating the alert information; and
in response to that the data migration is unsuccessful, generating the alert information.
